(19) United States
(12) Patent Application Publication
(10) Pub. No.: US 2021/0362995 A1
(43) Pub. Date: Nov. 25, 2021

(54) MODULARLY FILLABLE SANITIZER DISPENSER

(71) Applicant: KleenFreek, LLC., Northbrook, IL (US)

(72) Inventors: Robert W. Mead, Chicago, IL (US); Edward J. Franczek, Glencoe, IL (US); Brian Wendt, Naples, FL (US)

(21) Appl. No.: 17/329,923

(22) Filed: May 25, 2021

Related U.S. Application Data
(63) Continuation of application No. 63/029,591, filed on May 25, 2020.

(51) Int. Cl. B67D 3/00; A47K 5/12

(52) U.S. Cl. CPC B67D 3/0067; A47K 5/12

(57) ABSTRACT

A modularly configured hand sanitizing fluid storage and dispensing device is provided comprising an outer container that can be attached to a fixed object where hand sanitation is desired. The dispenser has an interior cavity accessible from the exterior, through a door, and a fluid reservoir attached to hand sanitizer dispensers, placed either on the device or connected distally by using tubing to feed fluid to the dispensers. The placement of the dispensers can be made in accordance with local codes or in accordance with the Americans with Disability Act, to provide users with hand sanitizing fluid. The fluid is placed in the outer container by using fluid modules comprising bag-in-box (BIB) modules that are, when inserted, in fluid communication with the reservoir, filling the reservoir upon insertion. The module can be readily replaced when empty, while leaving the reservoir of the container filled for use while the module is being replaced.

### FIELD OF THE INVENTION

The present invention concerns a device for the dispensing of liquid that sanitizes the user's hands. More particularly the present invention concerns a device that can be attached at convenient locations to provide sanitation of hands through the dispensing of a liquid having a high concentration of alcohol capable of killing a high percentage of genus found on the hands. The device is filled using a modular container of sanitizing fluid designed to fit into a fixed shell having one or more dispensing element attached thereto.

### BACKGROUND OF THE INVENTION

Immobile or stationary sanitizer dispensing mechanism or systems are traditionally difficult to keep supplied with sanitizer, are complicated to maintain overall and are often prone to breakage, user abuse, theft and malfunction. Currently available sanitizer dispensing systems are not designed for ease of operation and ease of maintenance or filling, especially by employees working in commercial or public locations.

With the present Covid pandemic, and for future of virus control and health issues, and as countries, states and municipalities reopen for business, returning the population to more public activities, the sanitizing of hands, more often and more readily, will continue to be critical in the fight to eliminate germs. The Covid threat has brought to light the threat of germs and viruses and the need to prevent the spread of such that we are likely to confront, in the future. The threat has also exposed the need for careful use of every ounce of sanitizing fluid as emergencies lead to shortages and hording and therefore the need for a system that can mininalize any loss of the fluid. Therefore, there is a real, current and critical need for stationary sanitizer dispensing systems that are easy to install, operate, maintain and fill while being less susceptible to abuse, theft or vandalism. This is all the more critical in application venues where the dispensing system of the current invention is intended to be used—gas station pump areas and automatic teller machines (ATMs) and other high traffic volume locations. Although the present invention is envisioned for these specific applications, persons having ordinary skill in the art will understand that the present invention can be adapted for other applications and uses in public or commercial settings.

The U.S. Centers for Disease Control and Prevention (the CDC) advises on its own website that:
“Germs are everywhere! They can get onto hands and items we touch during daily activities and make us sick. Cleaning hands at key times with soap and water or hand sanitizer that contains at least 60% alcohol is one of the most important steps you can take to avoid getting sick and spreading germs to those around you.
CDC recommends washing hands with soap and water whenever possible because handwashing reduces the amounts of all types of germs and chemicals on hands. But if soap and water are not available, using a hand sanitizer with at least 60% alcohol can help you avoid getting sick and spreading germs to others.”
   Source: Center for Disease Control Prevention website, see: https://www.cdc.gov/handwashing/hand-sanitizer-use.html

Therefore, now more than ever there is a critical need for the dispensing system as intended by the current invention.

It is therefore an object of the present invention to provide a means for the quick and wide-spread installation and maintenance (especially refilling) of sanitizer dispensing devices on or near existing public conveyances and devices so that a wide scope of the population will be able to sanitize their hands conveniently and easily. It is also an object of the present invention to provide a device for the sanitation of the hands that is easily kept loaded with sanitizing liquid, is easily refillable using prefilled packages or cartridges of sanitizing liquid and has a reservoir of sanitizing liquid therein to allow persons to sanitize their hands while the prefilled packages are being replaced. It is another object to provide such a device in a manner that can be installed in such a manner that it does not interfere with the operation of the device it is installed upon and can provide a location for advertising or informational information to be placed thereon, to aid in paying for the convenience of a sanitizer dispenser thereon. It is a further object, of the present invention that the device be refillable in a manner wherein the fluid is not exposed to the environment during filling and spillage or loss of fluid is not experienced during transfer.

Other objects and advantages of the present invention will become apparent as the description proceeds.

### SUMMARY OF THE INVENTION

In accordance with the present invention, a modularly configured hand sanitizer dispensing device, is provided, comprising an outer container configured with a reservoir section. The container has a door, which allows the user to access the interior of the container for fluid placement therein, and can hold a fluid receptacle inside of the container; the reservoir comprises at least one opening to allow for fluid to flow out of the device and air to enter the device. A removable inner container is designed to be held within the outer container, and comprises means, generally a fluid-tight bag, to hold fluid therein and allow the fluid to flow out into the reservoir, while air flows into the inner receptacle to relieve vacuum pressure. The inner receptacle and reservoir have cooperative elements, such as a nipple and receptacle to connect one with the other for the fluid to leave the receptacle and enter the reservoir. A dispenser is included on or connected to the device to cause fluid to flow to a user, from the reservoir, upon the activation of the dispenser.

In a preferred embodiment, the inner receptacle comprises a bag in a box (BIB) module. The BIB of the preferred embodiment is made of a corrugated cardboard box having a flexible bag, such as a plastic box, therein, which can be filled with sanitizing fluid at a central location and delivered to owners of the device of the present invention, thereby having users avoid the messy task of refilling sanitizer dispensers.

In some embodiments, the dispenser device is directly attached to the outer container, while in other embodiments, the dispenser is placed distally from the container and is in fluid connection with the device by a conduit, such as plastic tubing.

In a preferred embodiment the inner container or module and the outer container of the device each have a viewing window arranged so that when the module is within the outer container, the amount of fluid remaining therein can be viewed from outside of the device so that the user is aware of when the module should be replaced.

In some embodiments, the outer container of the device is generally a rectangular cuboid or box, but it will be understood that the device can be adapted to any shape as desired. A rectangular configuration, though, can be most easily configured to providing space to place advertisement or other information on an exterior surface thereof. In a preferred embodiment the device is provided with elements, such as flanges with openings for fasteners, so as to be fixable to a surface to provide security for the device and/or keep it from falling off the platform and hurting a user or otherwise damaging the device.

In some embodiments, the BIB is provided with a sensor that can determine from either the weight of the BIB or the elapsing of time that the BIB has been in place and send notifications to the user or to an ordering platform such that a new BIB can be ordered for replacement.

In a preferred embodiment, the inner container is configured as a fluid module for insertion and removal as needed. In some embodiments the inner container is refillable when it is empty and outside of the device to provide a savings from having to buy pre-filled modules.

Therefore, the preferred embodiment of the device is a modularly configured hand sanitizer dispensing device, having a generally rectangular-cuboid shaped outer container configured with a reservoir section, the container having a door with a window thereon. In use, the door allows access to the interior of the container. The device further has means to hold a fluid-tight module inside of the device, the reservoir comprising at least one opening for conveyance, in and out, of fluid and air. In the use of the device, provision for one or more removable fluid-tight modules is made. Each module comprising a window for viewing the contents therein, and configured to be placed within the outer container such that window of the module-in-place and the window of the container are aligned for viewing from the exterior of the device into the module-in-place to determine fluid level from outside of the device. The module-in-place is removable from the outer container for replacement with another module when needed; each of the modules comprising means to hold fluid therein and allow the fluid to flow out therefrom into the reservoir, while air flows into the inner module-in-place.

The inner module-in-place and reservoir connecting with each other upon placement of the module in the device for fluid conveyance from the module into the reservoir of the device. A dispenser, connected with, the inner module-in-place and outer container, is provided to cause fluid to flow from the reservoir to the user upon activation of the dispenser. The dispenser can be directly attached to the outer container or can be placed at a distance as desired.

The device can have a sign holder to display information or advertisements on an exterior surface. The device can be fixed to a surface, such as a gasoline pump, so that it is not susceptible to falling off the pump or being stolen.

A more detailed explanation of the invention is provided in the following description and claims and is illustrated in the accompanying drawings.

### BRIEF DESCRIPTION OF THE DRAWINGS

FIG. 1 is a cut-away view of one embodiment of the present invention.

FIG. 2 is a view of a modular sanitizing fluid insert for use in the embodiment, of FIG. 1.

FIG. 3 is close-up view of the connection of the modular fluid insert of FIG. 2 being inserted in the embodiment of FIG. 1.

FIG. 4 is a close-up view of the modular fluid insert of FIG. 2 in place in the embodiment of FIG. 1.

FIG. 5 is a cut-away view of the modular insert in place in the embodiment of FIG. 1.

FIG. 6 is a view of a second embodiment of the device of the present invention.

FIG. 6A is a view of the device of FIG. 6 conveniently in place on a gasoline station pump.

FIG. 7 is a third embodiment of the device of the present invention.

FIG. 7A is a view of the device of FIG. 7 conveniently in place on a gasoline station pump.

FIG. 7B is a view of a fluid bag used within the device of the present invention.

FIG. 8 is a view of the embodiment of FIG. 1 of the device of the present invention, in a dual dispense configuration.

FIG. 8A is a view of the device of FIG. 8 conveniently in place on a gasoline station pump

FIG. 9A is a partially cut-away view of a different means of connecting a modular fluid insert into a device made in accordance with the present invention.

FIG. 9B is a partially cut-away view of another device made in accordance with the view shown in FIG. 9A.

FIG. 9C shows a perspective view of the devices of FIG. 9B.

FIG. 10A shows a perspective view of an embodiment of a device made in accordance with the teachings of the present invention.

FIG. 10B shows a perspective view of an embodiment of a device made in accordance with the teachings of the present invention, with an open access door.

FIG. 11A shows a perspective view of another embodiment of the devices of FIG. 9B.

FIG. 11B shows a device of FIG. 11A with advertisement thereon.

FIG. 11C shows the device of FIG. 11A conveniently placed on a gas station pump.

### DETAILED DESCRIPTION OF THE ILLUSTRATIVE EMBODIMENT

While the present invention is susceptible of embodiment in various forms, there is shown in the drawings a number of presently preferred embodiments that are discussed in greater detail hereafter. It should be understood that the present disclosure is to be considered as an exemplification of the present invention, and is not intended to limit the invention to the specific embodiments illustrated. It should be further understood that the title of this section of this application (“Detailed Description of the Illustrative Embodiment”) relates to a requirement of the United States Patent Office, and should not be found to limit the subject matter disclosed herein.

Referring now to the drawing figures, there is shown therein a device, and various embodiments thereof, made in accordance with the teachings of the present invention. The device is designed to hold and dispense liquids, most preferably a liquid with sufficient properties to kill germs to the degree, as determined by the CDC, to safely allow personal interaction with persons and objects while interdicting the spread of bacteria, germs and viruses and any other susceptible pathogens. While the drawing figures show the use of the device in association with a gasoline pump device, it will be understood by persons having ordinary skill in the art, that the device can be used in or on any surface or device accessible to the public or to a person, including but not limited to: hard wired telephones, computers, copiers, and other office devices, countertops, tables, desks, podiums, lecterns, daises, wash stations, restrooms, restaurant counters, tables and pay stations, cash registers and many other locations wherever persons come in contact with surfaces, as will be explained below.

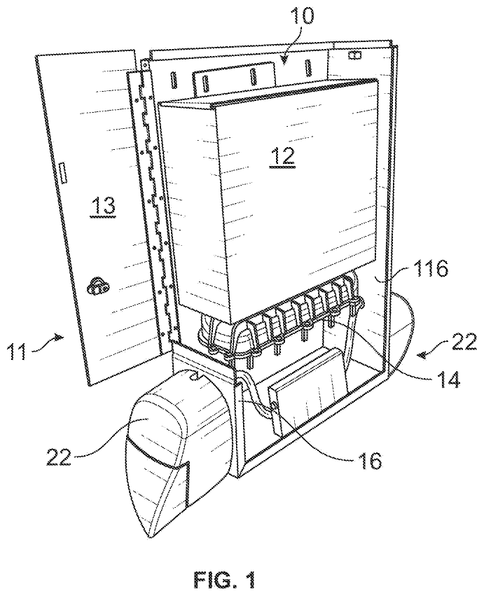

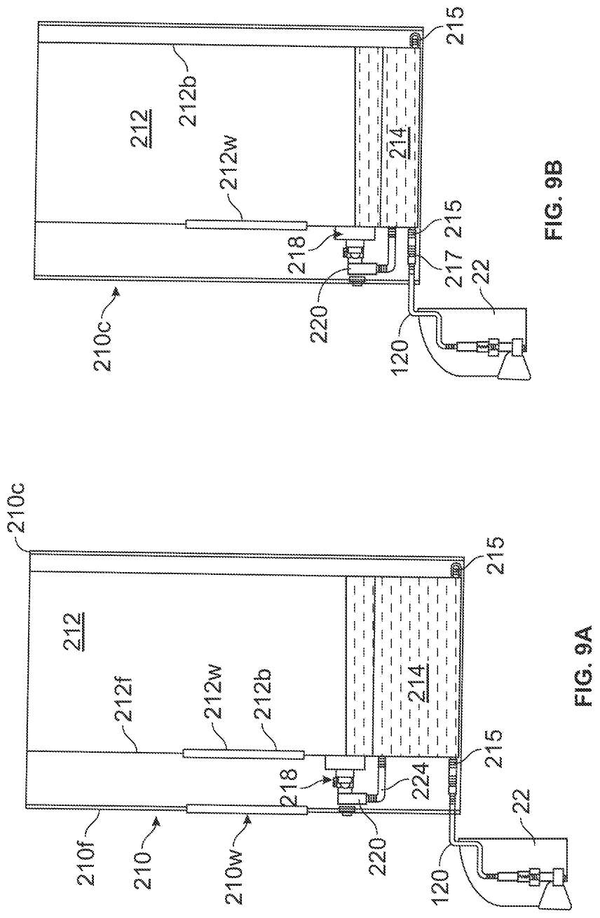

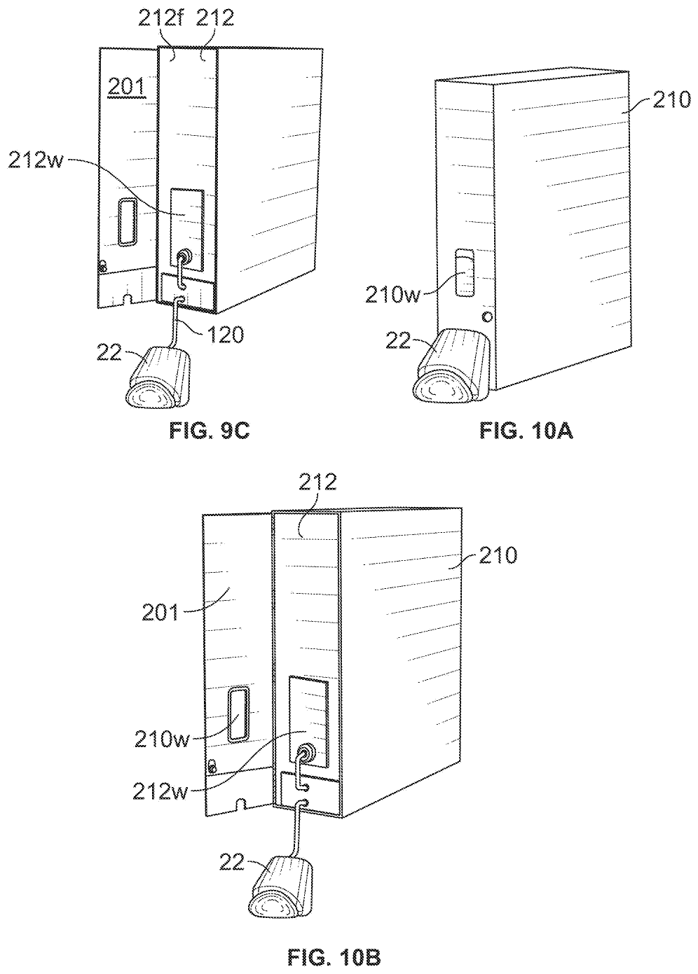

Referring now to FIG. 1, a device 10, formed as a generally rectangular box 11. cut away to show the interior 11i, has a modular fluid container 12 therein. It will be seen that device 10 is generally a rectangular box 11 with a hinged door 13. While not shown in the images, device 10, when complete, has a top and side to fully enclose the container 12 therein. The device further can include a lock on the door to keep the contents therein from being stolen or vandalized. Container 12, in a preferred embodiment, is a corrugated cardboard box 12b with a flexible bag 12f therein, as most clearly shown in FIGS. 9A. The combination of the cardboard box 12b and flexible bag 12f is referred to as a bag in box (BIB), a modular unit having sanitizing fluid therein. It, will be understood, by persons having ordinary skill in the art, that the flexible bag can be of any type of plastic, rubber, vinyl or other material that allows watertight containment of the sanitizer fluid, to be placed therein and without chemical reaction to the fluid, can be used without departing from the novel scope of the present invention. Schematic views of a completed exterior of the box 11 are shown in FIGS. 9C and 10A, which will be described in greater detail below. The device 10 further comprises a reservoir 14, located below and in fluid connection with container 12 and a fluid dispenser 22 (shown in greater detail below) located on the panel 16, under the door 13. It will be seen that, in the present embodiment, a second dispenser 22 is provided on a panel opposite to panel 16, at the rear of device 10, allowing users to secure sanitizing fluid from both sides of the device simultaneously.

Upon the placement of container 12 upon reservoir 14, fluid is allowed to flow into reservoir 14, as will be discussed in further detail herein. A sanitizing fluid dispenser 22, of a type known to persons having ordinary skill in the art is shown attached to box 11; it will be understood, and shown in various embodiments below, that dispenser 22 can be attached to box 11 or can be extended from box 11 and attached elsewhere using tubing. It will also be seen that in the present embodiment two dispensers are included with device 10, but that any number of dispensers, as needed and desired, can be used in the present invention, without departing from the novel scope thereof.

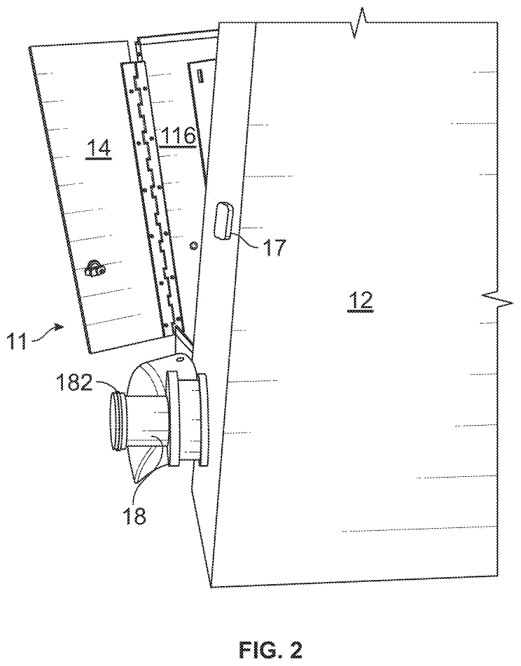

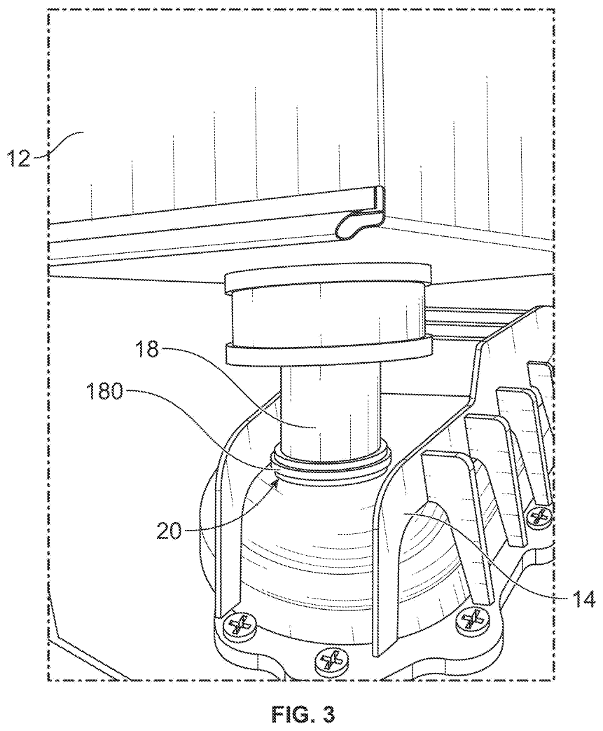

FIG. 2 shows a container 12 apart from box 11. It will be seen that container 12 is a BIB having a connection nipple 18 for sealable insertion into receptor 20 of reservoir 14 (FIG. 3). Persons having ordinary skill in the art will know that the connection of container 12 to reservoir 14 can be made in numerous ways to allow fluid flow, without departing from the novel scope of the present invention (as will be shown with respect to FIGS. 9, 10 and 11). An important element is to create a connection that allows both the flow of fluid into reservoir 14 and the return of air into container 12 from reservoir 14 or other venting location, so as to prevent a vacuum lock between the reservoir and supply container 12.

It will be understood that in some embodiments a sensor 17, of a type, known to persons having ordinary skill in the art, which can sense a parameter and send electronic notifications, can be attached to BIB or supply container 12, in a manner also known to persons having ordinary skill in the art, such as with an adhesive or a fastener or manufactured integrally with BIB 12, all without departing from the novel scope of the present invention. The sensor can be programmed to determiner either by the comparable weight of the BIB 12 or the time elapsed since placement in device 10, that the BIB 12 needs to be replaced. Persons having ordinary skill in the art will understand that the sensor 19 can be programmed to provide notice to the user, or to a cooperative ordering service, to notify the user that the BIB 12 needs to be replace, or to order a replacement BIB 12 in time for a new BIB 12 to be received for replacement, as desired. It is envisioned that the user will be able to choose to receive a notice, order a replacement or both with available programming.

As shown in FIG. 3, container 12 is seated onto reservoir 14 when nipple 18 is inserted into receptor 20. As can be seen, nipple 18 includes an O-ring 18o to aid in the sealing of these elements together. It will be understood that receptor 20 can include means (not shown) to open a breakable seal to allow for flow of the fluid. Further, nipple 18 is of a type that, when it is placed upon receptor 20, is opened to flow of fluid and air therebetween, and when removed from receptor 20 is sealed such that fluid cannot flow therefrom. In this manner, the placement and removal of container 12 from device 10 can be made with no loss of fluid therefrom. Persons having ordinary skill in the art will recognize the numerous types of such cooperative means permitting the clean insertion and removal of container 12 from device 10, use of which does not depart from the novel scope of the present invention.

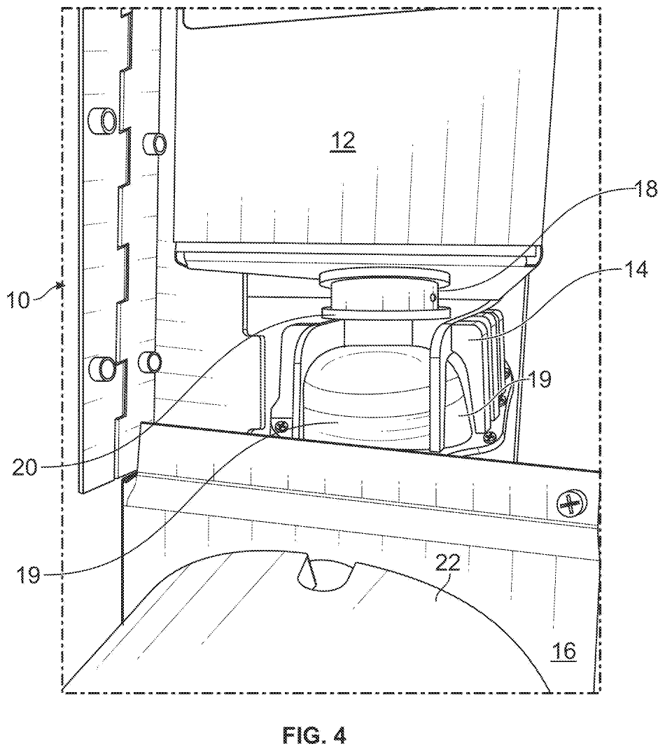

In FIG. 4 the BIB 12 is in place in device 10; nipple 18 is inserted into receptor 20 of reservoir 14 and fluid 19 can be seen within reservoir 14. As can be seen, the use of device 10 includes the steps of placing a BIB 12 in the manner explained above, when it is determined that the BIB 12 is in need of replacement (for example, when the fluid has been depleted). Therefore, in the use of device 10 of the present invention, when the device is put into operation, a BIB is seated in the device, as explained above, fluid flows into reservoir 14 and then out through dispenser 22 as it is manipulated by a person. When it is determined that the device needs to be refilled, a new BIB 12 is brought to the device, the extant BIB 12 is removed and the new BIB 12 is replaced therefore. It will be understood that during this time, the reservoir 14 remains with fluid therein, allowing users to continue to secure sanitizing fluid for immediate use at all times. The device 10 allows use before, during and after it is refilled using a modular BIB 12.

As disclosed, because the BIB 12 first fills a reservoir 14, within device 10, upon being seated in position in device 10, when the BIB 12 is removed for replacement, reservoir 14 continues to have fluid therein such that use of the sanitizing device 10 can continue while the device is being serviced. Because there is no interruption in the ability of users to sanitize with the present invention, even during refilling of the device, persons will always and continuously have the ability to secure sanitizing fluid via the device 10.

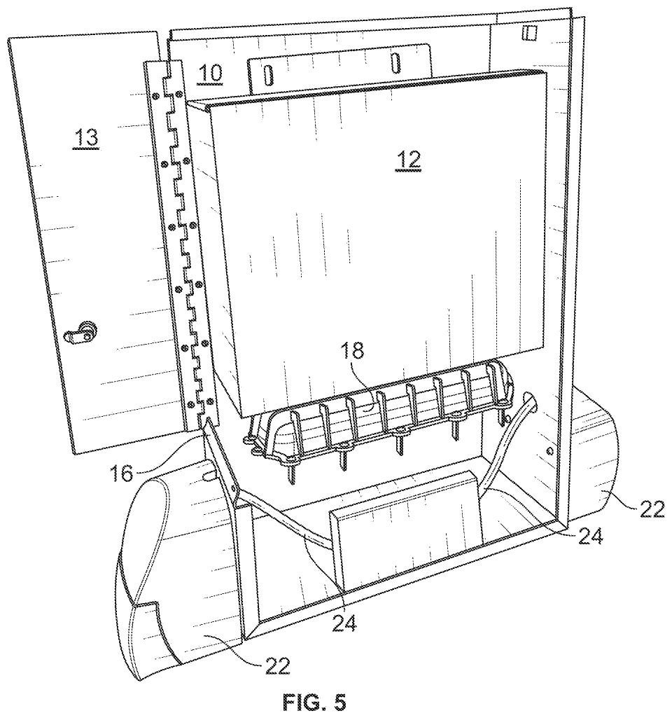

Referring now to FIG. 5, a view of the entire side of device 10, in configuration ready to use, is shown in an open configuration for ease of view. The connection of the various elements has been discussed above. It can be seen that a venting tube 24 is provided to allow fluid to flow more readily to dispensers 22, avoiding a vacuum problem that is often created when liquid is removed from a package.

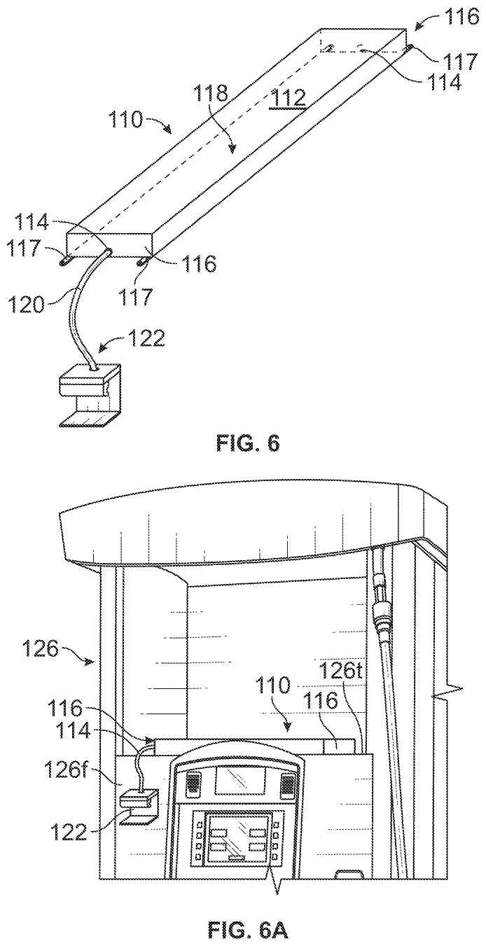

FIG. 6 shows another embodiment of the device 110 of the present invention, in its most simplified form. As illustrated, a simple liquid tight rectangular box 112 is provided having one or more openings 114, which one or more can be sealed with any stopper-type mechanism (not shown) of any type known to persons having skill in the art, on one or more ends 116 of box 112 and/or can be connected to conduit or tube 120 that allows for flow in or out, as will be explained below. It will be understood that either or both openings 114 can be connected to conduits 120, allowing flow from one side or the other or both. Box 112 forms a reservoir 118, into which sanitizing fluid is placed. Box 112 comprises attachment tabs 117 that allow the device to be attached, typically by fasteners, to the surface where box 112 is used, so as to secure box 112 in place to facilitate use and to provide some security for the device (especially during times when sanitizing fluid is in short supply and the device could otherwise be taken). It will be understood by persons having ordinary skill in the art that attachment tabs 117 can be any type of device that can be used to affix one item to another; in the present embodiment, tabs 117 are shown as extended flanges having an opening therein that permit the device to be attached using screws or other fasteners. However, the device 10 could be attached to another surface with adhesives, hook and loop fasteners, welds or magnets without departing from the novel scope of the present invention. It will be understood that placing device 10 or 110 or any device made in accordance with the present invention, at elevation serves the purposes of keeping device 10 secure from vandalism or theft along with facilitating the gravitational flow of fluid.

Persons having ordinary skill in the art will understand that at least one of the openings 114 will allow a conduit, such as tube 120, to be attached thereto. Tube 120 will typically be of a flexible material, such as rubber, and be of a desirable length so that it can, at least, reach to a dispenser nozzle 122, of a type known to persons having ordinary skill in the art as will be described in more detail below. Persons having ordinary skill in the art will understand that the one or more openings 114 can also be used to allow reservoir 118 in rectangular box 112 to be filled. With more than one opening 114, an opening not attached to a tube 120, can be used to vent the interior of box 112 so that sanitizing fluid can flow easier out of reservoir 118, and concomitantly, flow into reservoir 118 when the device 110 is being refilled. It will be understood as well, that a BIB (not shown) of the type noted above, can be placed into box 112 and connected to tube 120 to allow the flow of sanitizing fluid.

Referring now to FIG. 6A, the device 110, is shown in place conveniently on a top surface 126t of a gasoline pump 126; while dispenser 122 is attached, by any means known to persons having ordinary skill in the art, to a front surface 126f of gasoline pump 126, in a position likely to be accessible to all persons, in accordance with such regulations as those imposed by the Americans with Disability Act (ADA). A length of conduit or tube 120 connects box 112 to dispenser 122, via opening 114, such that when the reservoir 118 of box 112 is filled with sanitizing fluid, and dispenser 122 is activated, sanitizing fluid will flow out of reservoir 118, through tube 120, via opening 114, to dispenser 122 and onto the hand of a user.

While a gasoline pump device 126 is being utilized here to show a location for the placement of the device of the present invention, it will be understood that the present invention can be used in association with any such device, or on any surface, or with a stand made specifically for the devices 10 and 110, and others that will be shown as the description continues, without departing from the novel scope of the present invention. A gasoline pump 126 is shown as it represents a type of device wherein many persons will have access to the device and will use a hand to hold and place the nozzle of the gasoline pump (not shown), thereby having a likelihood of acquiring germs, bacteria or virus from a prior user and thereby having a need to sanitize the hand(s) after such contact. Persons having ordinary skill in the art will understand that this is merely an example. and that the device of the present invention will find a use and mounting location in many situations, including any location where the user's hands are exposed to devices or surfaces previously touched by prior users. Such places and devices as public restrooms, public telephones, payment stands in stores and/or restaurants, counter top service areas, such as government offices and private offices, can be substituted for the gasoline pump shown here without departing from the novel scope of the present invention.

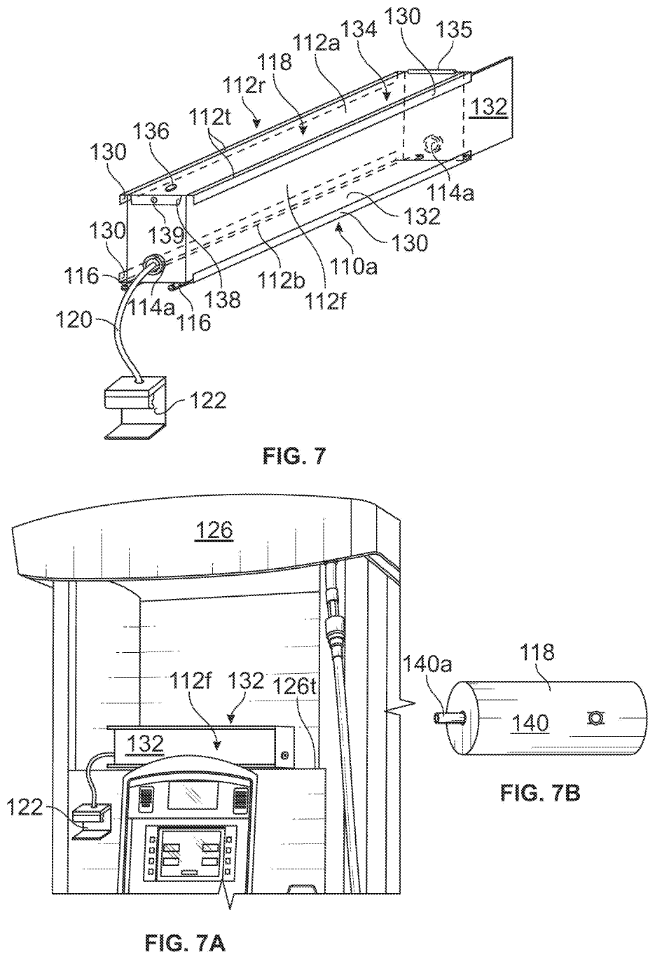

Referring now to FIG. 7, it will be seen that another embodiment of the present invention is shown. In FIG. 7, a box 112a of the type shown in FIG. 6 is provided, with openings 114a, in the same manner as that shown in FIG. 6. In the present embodiment, flanges 130 are provided along the top 112t and bottom 112b edges of box 112, both on the front side 112f and rear 112r of box 112. Flanges 130 are designed such that an advertising or informational sign 132 can be placed within flanges 130 to provide information to users of the device, in a manner known to persons having ordinary skill in the art. Box 112, further comprises a top panel 134, being attachable to box 112a by a hinge 135, a lock 136 and a closing flange 138 having a knob 139 thereon. Top panel 134, in this configuration, can be pivotably opened using hinge 135, by unlocking lock 136 and rotating top panel 134 up using knob 139 to hold and lift top panel 134. The opening of box 112a in this manner will facilitate access to and the filling of reservoir 18, therewithin.

As shown in FIG. 6, the device 110a of FIG. 7 can be attached to any desirable item, here a gasoline pump 26 is shown, using attachment tabs 116 to provide sanitizer fluid where desired and at a desirable altitude to stem vandalism and theft and facilitate gravitational flow, as noted above. It will be understood that device 110a can be made so that the box 112a of the device is watertight to hold sanitizing fluids within its walls; however, in the present example, a bag 140 is provided to hold a specific quantity of sanitizer therein and thus, within reservoir 118 of box 112a. It will be understood, by persons having ordinary skill in the art, that bag 140 can be of any shape or type as long as it fits within reservoir 118 of device 110 and is capable of holding sanitizer fluid therewithin until needed. In the present embodiment, bag 140 is provided with a connection element 140a, such as a nozzle, that is attachable within the inside of box 112a at opening 114a of device 132, so as to make a connection between bag 40 in reservoir 118 and hose 120 and dispenser 122. It will also be understood that a BIB 12, of the type shown in the first embodiment of the application, can be used and placed within box 112a, connecting with the box using a nipple device explained above, or a mor simplified connection using tubes 120 for direct connection to the BIB 12, all without departing from the novel scope of the present invention.

As the embodiment in FIG. 7 is provided with an operable top 134, it will be understood that sanitizing fluid can be brought to device 110a and placed within box 112a by unlocking the lock 136, pulling on knob 139 and rotating top 134 with hinge 135 to provide access to reservoir 118. Bag 140, or a BIB 12, can then be attached, via nozzle 140a to opening 114a, and placing bag 140 within reservoir 118 and closing top 134 (by reversing the steps described herein) and locking top 134 in a closed position relative to box 112a. As such, when it is determined that the device 110a is out of fluid, after placement and use, a new bag 140, or BIB 12, of sanitizer fluid can be brought to the device 110a to refill the sanitizer device 110, for continued uninterrupted use. In regular use, a time period for removing the bag 140 and replacing it with another bag 140, filled with sanitizer fluid, can be created such that device 110a is never left without sanitizing fluid. It will be understood that bag 140 of the present embodiment can be of a type that is refillable once it is removed from device 110a or can be of a type where a single use is possible for such a bag. Persons having ordinary skill in the art will understand that the use of either a refillable or one-use bag can be made in the present device without departing from the novel scope of the present invention.

FIG. 7 shows a dispenser element 122, similar to that shown in FIG. 6, with a concomitant tube 120 and mounting of the type described before. It will be understood by persons having ordinary skill that the mounting and use of dispenser 122 will be similar or identical to that described above with respect to the use of the device shown in FIG. 6 and FIG. 6A. Referring to FIG. 7A, the attachment of the device 110 of the present invention to a gas pump device 126 is shown, and is similar to that shown in FIG. 6A. Because dispenser 122 is attached to a tube 140, it can be placed distally from device 110 at a position more convenient for use by persons needing sanitizing fluid. In some embodiments, this distal attachment is made compliant with such laws as the Americans with Disabilities Act (ADA).

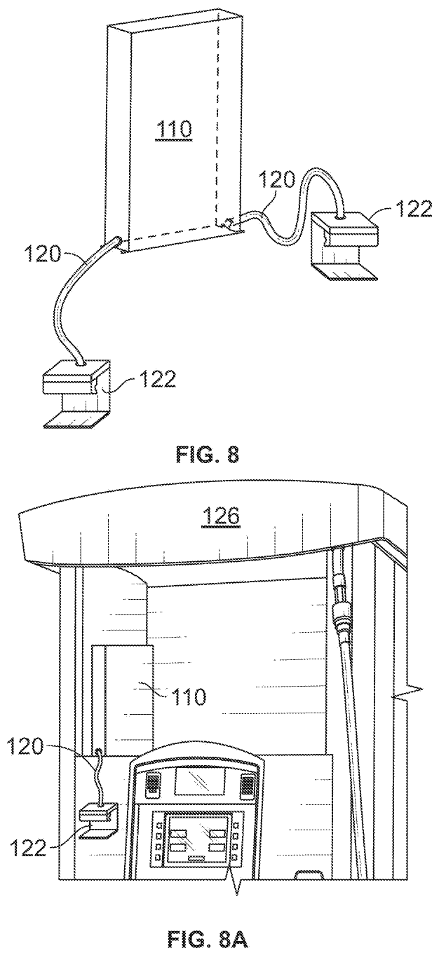

Referring now to FIG. 8, a stylized view of device 10 (of FIG. 1) is shown utilizing some of the connection elements shown in FIGS. 6 and 7, including tubing 120 to provide distal connection of dispensers 122, from two sides of device 10, at extended lengths therefrom. FIG. 8A, shows the device in place on a gasoline pump 126, with dispensers located at a convenient height, on either side of pump 126, for use by patrons of the gasoline station.

FIGS. 9A, 9B and 9C are of further embodiments of the device 10, shown as 210 here, of the present embodiment, with some distinctions. FIGS. 9A, 9b and 9c are related embodiments, having elements that can be employed in each of the embodiments of the present invention. It will be seen that the devices of FIGS. 9A and 9B are very similar, one having a larger reservoir 214 section than the other. In the present embodiment, the connection of the BIB 212, differs from that shown in prior embodiments in that the nipple 218 of BIB 212 attaches via a connecter 220, acting similarly to receptor 20 of FIG. 3. The pushing of receptor 220 onto nipple 218 provides the connection of BIB 212 to device 210; flow of sanitizing fluid into reservoir 214 is made via tube 224 between receptor 220 and reservoir 214, in a manner known to persons having ordinary skill in the art. Fluid from reservoir 214 then can flow to dispenser 22, attached to reservoir 214 via tube 120 attached to reservoir access point 215, as was described with respect to dispensers of prior embodiments. It will be understood that one or more dispensers 22 can be attached to the device of the present invention, a second attachment point 215 is provided in the present embodiment. It will be seen that tube 120 is attached to attachment point 215 via a ventilation device 217 so as to allow steady flow of fluid without vacuum issues interdicting flow, as known by persons having ordinary skill in the art.

It will be seen that certain embodiments of device 210, include a window 210w on the front panel 210f of container 210c of device 210. In the present embodiment, BIB 212 comprises a solid box 212a having a flexible bag 212b therewithin, as discussed above bag 212b being made, at least in part (for example front panel 212f), of a transparent material. As shown in FIG. 9C, BIB 212 comprises a box having a window 212w, through which the level of fluid within BIB 212 can be viewed. When BIB 212 is placed in container 210c, and door 201 is closed, a user can look through window 210w and window 212w, which coincide with each other, to see the level of fluid remaining therein to help determine if BIB 212 needs to be replaced to keep the device supplied with fluid.

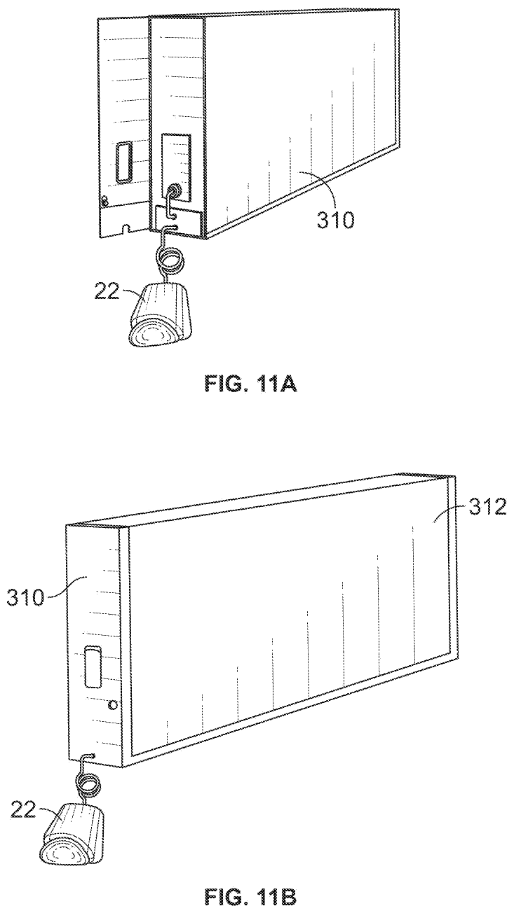

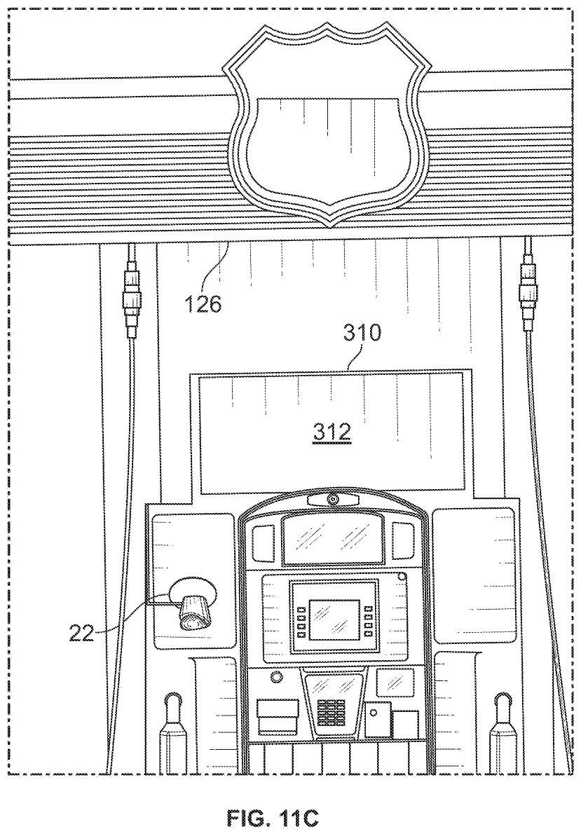

FIGS. 10A and 10B further illustrate the coincidence in windows 210w and 212w in use with both a dispenser 22 attached directly to the device 210 and attached distally, as described above. FIGS. 11, 11A and 11B illustrate the placement of device 310, made in a landscape configuration (instead of a portrait configuration shown above), on a gasoline pump 126 (affixed in a manner as described above) having elements, as illustrated in FIG. 7, for the placement of signage 312 (showing advertisement or other information) thereon. The configuration of device 310 can be of any type illustrated in the present invention as described herein, without departing from the novel scope of the present invention. Device 312 is shown having the elements allowing for viewing whether the device needs refilling, but can be of any embodiment disclosed herein.

Although an illustrative embodiment of the invention has been shown and described, it is to be understood that various modifications and substitutions may be made by those skilled in the art without departing from the novel spirit and scope of the invention.

What is claimed is:

1. A modularly configured hand sanitizer dispensing device, comprising:
an outer container configured with a reservoir section, the container having a door allowing access to the interior of the container for fluid placement therein and means to hold a fluid receptacle within the outer container, the reservoir comprising at least one opening for conveyance, in and out, of fluid and air;
a removable inner receptacle, configured to be held within the outer container, and comprising means to hold fluid therein and allow the fluid to flow out therefrom, into the reservoir, while air flows into the inner receptacle;
the inner receptacle and reservoir comprising cooperative means to connect one with the other for fluid conveyance; and
a dispenser, in fluid communication with the inner and, outer container, configured to cause fluid to flow, to a user, from the reservoir upon the activation of the dispenser.

2. The modular configured hand sanitizing dispensing device of claim 1, wherein inner receptacle comprises a bag in a box (BIB) module.

3. The modular configured hand sanitizing dispensing device of claim 1, wherein the dispenser is directly attached to the outer container.

4. The modular configured hand sanitizing dispensing device of claim 1, wherein the dispenser is placed distally from the container and is in fluid connection with the device by a conduit.

5. The modular configured hand sanitizing dispensing device of claim 1, wherein the inner container and device each comprise a window arranged such that the fluid in the inner container can be viewed from outside of the device.

6. The modular configured hand sanitizing dispensing device of claim 1, wherein the device is generally a rectangular cuboid.

7. The modular configured hand sanitizing dispensing device of claim 1, wherein the device comprises means to display information on an exterior surface thereof.

8. The modular configured hand sanitizing dispensing device of claim 1, wherein the device is fixable to a surface.

9. The modular configured hand sanitizing dispensing device of claim 1, wherein the inner container is configured as a fluid module for insertion and removal as needed.

10. The modular configured hand sanitizing dispensing device of claim 1, wherein the inner container is refillable when it is empty and outside of the device.

11. The modular configured had sanitizing dispensing device of claim 1, including a sensor in communication with the inner container and a receiving device to provide notice of remaining fluid therewithin.

12. The modular configured had sanitizing dispensing device of claim 11, wherein the sensor is programmed to order a replacement inner container from a preprogrammed source at a preprogrammed weight trigger, or time period, provided by the sensor.

13. A modularly configured hand sanitizer dispensing device, comprising:
A generally rectangular-cuboid shaped outer container configured with a reservoir section, the container having a door having a window, the door allowing access to the interior of the container and means to hold a fluid-tight module therein, the reservoir comprising at least one opening for conveyance, in and out, of fluid and air;
one or more removable fluid-tight modules, each module comprising a window for viewing the contents therein, each module configured to be placed within the outer container such that window of the module-in-place and the window of the container are aligned for viewing from the exterior of the device into the module-in-place, the module-in-place being removable from the outer container for replacement with another of the one or more removable fluid-tight modules, each fluid-tight module comprising means to hold fluid therein and allow the fluid to flow out therefrom into the reservoir, while air flows into the inner module-in-place;
the inner module-in-place and reservoir comprising cooperative means to connect one with the other for fluid conveyance; and
a dispenser, in fluid communication with the inner module-in-place and outer container, configured to cause fluid to flow, to a user, from the reservoir upon the activation of the dispenser.

14. The modular configured hand sanitizing dispensing device of claim 10, wherein the dispenser is directly attached to the outer container.

15. The modular configured hand sanitizing dispensing device of claim 10, wherein the dispenser is placed distally from the container and is in fluid connection with the device by a conduit.

16. The modular configured hand sanitizing dispensing device of claim 10, wherein the device comprises means to display information on an exterior surface thereof.

17. The modular configured hand sanitizing dispensing device of claim 10, wherein the device is fixable to a surface.

18. The modular configured had sanitizing dispensing device of claim 13, including a sensor in communication with the inner container and a receiving device to provide notice of remaining fluid therewithin.

19. The modular configured had sanitizing dispensing device of claim 19, wherein the sensor is programmed to order a replacement inner container from a preprogrammed source at a preprogrammed weight trigger, or time period, provided by the sensor.
